(19) United States
(12) Patent Application Publication
(10) Pub. No.: US 2025/0155116 A1
(43) Pub. Date: May 15, 2025

(54) LIGHT EMITTING DEVICE HAVING A CAMERA

(71) Applicant: Invention Station, LLC, Scottsdale, AZ (US)

(72) Inventors: Russell Wood, Queen Creek, AZ (US); Rylee Robinson, Scottsdale, AZ (US); Brian Pry, Sacramento, CA (US)

(21) Appl. No.: 18/912,016

(22) Filed: Oct. 10, 2024

Related U.S. Application Data
(60) Provisional application No. 63/548,500, filed on Nov. 14, 2023.

(51) Int. Cl. F21V 33/00; A01G 7/04; F21V 17/00; F21Y 115/10; H05B 47/16

(52) U.S. Cl. CPC F21V 33/0052; A01G 7/045; F21V 17/002; F21Y 2115/10; H05B 47/16

(57) ABSTRACT

A light emitting device includes a camera assembly with a cover section housing LEDs, a top section with a camera protrusion, an image sensor and lens module, and a base section. The cover section, which can be partially or fully transparent, is removably attached to the top section. The LEDs are arranged in three rings of increasing diameter size, emitting green, red, or yellow light. The image sensor and lens module are coupled to a main or secondary printed circuit board (PCB) in the controller. The cover section has a hole for the camera protrusion, which has a removable lens. The base section is coupled to a mounting adapter plate. The device can be used to provide camera security for indoor growing facilities, with the LEDs configured to mimic natural light conditions for plant species, including nighttime lighting or moonlight, and can be controlled to affect different growth stages.

### CROSS REFERENCE TO RELATED APPLICATION

The present application claims the benefit under 35 U.S.C. 119 of U.S. Provisional Patent Application Ser. No. 63/548,500 filed Nov. 14, 2023. The U.S. Provisional Patent Application Ser. No. 63/548,500 is hereby incorporated by reference in its entirety.

### FIELD OF THE INVENTION

This invention pertains to a light emitting device with an integrated camera assembly, and more specifically to a device that combines removable LED lighting with imaging capabilities in a single, compact unit for allowing a user see in a dark grow room.

### BACKGROUND OF THE INVENTION

Plant cultivation has been a fundamental practice throughout human history, supporting agriculture, horticulture, and the production of food, fiber, and ornamental plants. The growth and development of plants are fundamentally reliant on the availability and quality of light. Natural sunlight provides a full spectrum of light, encompassing various wavelengths, which plants utilize for photosynthesis and photomorphogenesis. Plants have evolved to use the amount of sunlight available as a signaling resource to tell the plant, for example, when to begin a new growth stage. Plant biological activity is reactive to the number of various wavelengths of light that are absorbed. In addition, emitting infrared light can damage and mutate a crop.

Modern agriculture often involves controlled indoor environments and greenhouses, where natural light may be limited or inconsistent. To overcome these challenges and to optimize plant growth, artificial lighting systems have been developed and utilized for decades. These systems primarily employ various types of lamps, such as fluorescent, high-intensity discharge (HID), and light-emitting diode (LED) lamps, to provide the necessary light for plants in indoor or controlled environments.

In recent years, there has been a growing body of research and innovation in the field of plant lighting, with a particular focus on the spectral quality of light. Studies have shown that manipulating the light spectrum, particularly the balance of blue and red light, can have profound effects on plant growth, morphology, and developmental processes. This has led to advancements in LED-based lighting technologies designed to meet the specific needs of different plant species and their growth stages. The growth stages typically include germination and seedling stage, vegetative stage, pre-flowering stage, and flowering stage. Each stage requires different durations of light. For example, at the flowering stage typically red light is crucial for bud and flowering development for a 12-hour period of time and then the plants require 12-hour dark cycle mimicking natural conditions. During the dark cycle growers still need access to the inside of the grow facility, however certain light spectrums can affect plant growth. Current systems create a potential for plant deformations if light is on during the dark stage and may cause bodily harm to the user if completely dark within the grow room.

Therefore, there is a need for a light emitting device with an integrated camera assembly that addresses these issues. The present invention seeks to provide a solution that combines an interchangeable light source that is safe for the plants and the user and a camera in a single, compact unit, simplifying assembly and maintenance, and offering greater flexibility and adaptability.

### BRIEF SUMMARY OF THE INVENTION

The present invention is directed towards a light emitting device with an integrated camera assembly, designed to provide both illumination, safety and security for indoor growing facilities. The device comprises a cover section with an LED housing coupled to a back cover housing, wherein at least one LED is situated between the LED housing and the back cover housing. The device can also include a top section with a top housing featuring a camera protrusion. At least one image sensor and lens module are coupled to the camera protrusion and at least one controller. The device can further include a base section coupled to the top section, housing the image sensor, lens module, and controller.

The cover section can be designed to be removably attached to the top section. The cover section of the device can be partially or fully transparent. The LED component can consist of three rings increasing in diameter size, capable of emitting green, red, blue, or yellow light. The controller may include a main printed circuit board (PCB) and a secondary PCB, to which the image sensor and lens module are coupled. The main PCB has at least one second electrical contact. The cover section may also feature at least one hole for the camera protrusion to protrude through. Each ring of the LED component has at least one first electrical contact, which can be removably connected with the second electrical contact, completing the circuit between the main PCB and the three rings.

The camera protrusion can have a lens removably coupled to it. The base section of the device can be coupled to a mounting adapter plate. The camera is capable of using light from the entire spectrum.

The invention also includes a method of providing security for indoor growing facilities. The method involves using the light emitting device, wherein the LED is configured to mimic natural light conditions for at least one plant species. The LED can mimic nighttime lighting, emit green light, or mimic moonlight. The method may also involve swapping the LED and controlling the timing of the lighting to affect a growth stage, such as germination, seedling, vegetative, pre-flowering, and flowering stages.

It is an objective of the invention to reduce power consumption of the lighting system by as much as 90% overnight.

It is another objective of the invention to provide green lighting to hallways and grow rooms protecting the plants and allowing the staff to safely walk around in a dark grow room.

It is another objective of the invention to provide a single light source in a building instead of having multiple work and grow lights.

It is another objective of the invention to provide lighting at night that the plants will not absorb just like the light from the moon.

Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the. Absent such clear statements of intent to apply a “special” definition, it is the inventor's intent and desire that the simple, plain, and ordinary meaning to the terms be applied to the interpretation of the specification and claims. Aspects and applications of the invention presented here are described below in the drawings and detailed description of the invention. Aspects and applications of the invention presented here are described below in the drawings and detailed description of the invention.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

### BRIEF DESCRIPTION OF THE DRAWINGS

A more complete understanding of the present invention may be derived by referring to the detailed description when considered in connection with the following illustrative figures. In the figures, like reference numbers refer to like elements or acts throughout the figures.

FIG. 1 depicts a bottom isometric view of the light emitting device in accordance to one, or more embodiments;

FIG. 2 depicts a top isometric top view of the light emitting device in accordance to one, or more embodiments;

FIG. 3 depicts a side view of the light emitting device in accordance to one, or more embodiments;

FIG. 4a depicts a partial exploded side view of the light emitting device in accordance to one, or more embodiments;

FIG. 4b depicts a cross-sectional view of FIG. 4a of the light emitting device in accordance to one, or more embodiments;

FIG. 5 depicts an exploded side view of the light emitting device in accordance to one, or more embodiments;

FIG. 6 depicts a top isometric view of the light emitting device in accordance to one, or more embodiments;

FIG. 7 depicts a bottom isometric view of the light emitting device in accordance to one, or more embodiments;

FIG. 8a depicts a side view of the light emitting device in accordance to one, or more embodiments; and

FIG. 8b depicts a cross-sectional view of FIG. 8a of the light emitting device in accordance to one, or more embodiments.

Elements and acts in the figures are illustrated for simplicity and have not necessarily been rendered according to any particular sequence or embodiment.

### DETAILED DESCRIPTION

In the following description, and for the purposes of explanation, numerous specific details are set forth to provide a thorough understanding of the various aspects of the invention. It will be understood, however, by those skilled in the relevant arts, that the present invention may be practiced without these specific details. In other instances, known structures and devices are shown or discussed more generally to avoid obscuring the invention. In many cases, a description of the operation is sufficient to enable one to implement the various forms of the invention, particularly when the operation is to be implemented in software. It should be noted that there are many different and alternative configurations, devices, and technologies to which the disclosed inventions may be applied. The full scope of the inventions is not limited to the examples that are described below.

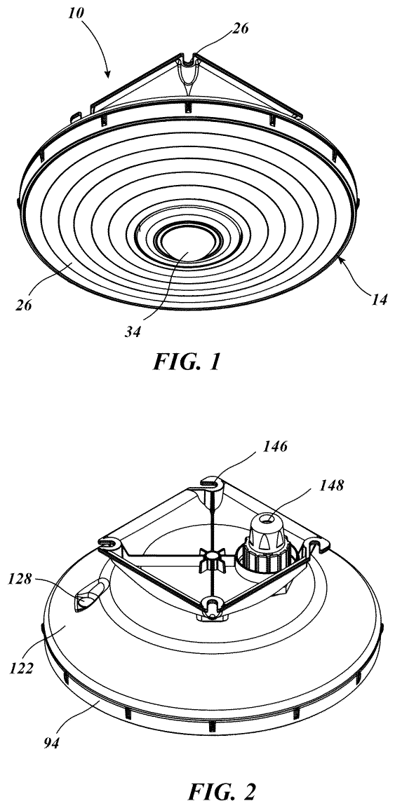

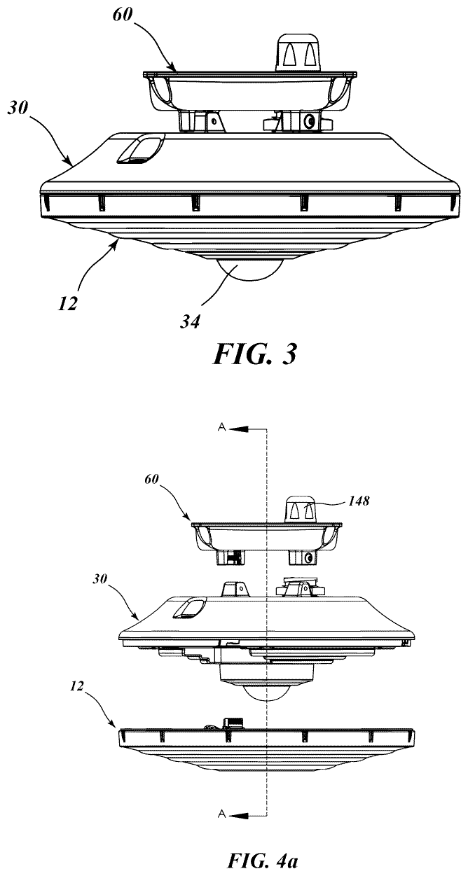

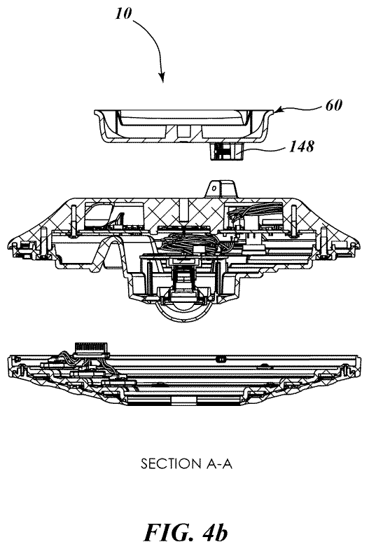

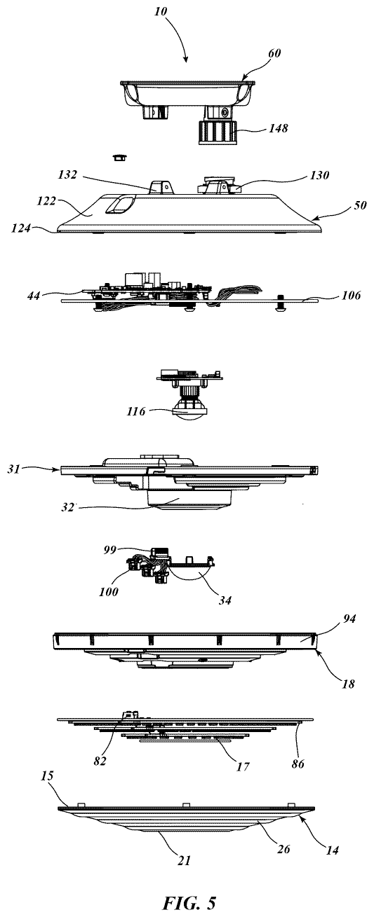

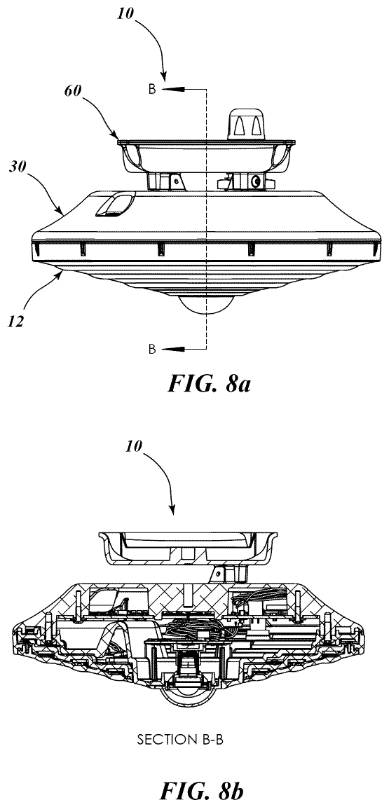

Referring to FIGS. 1-8b, light emitting device having a camera assembly is shown generally at 10. The light emitting device 10 can comprise a cover section 12, a top section 30 and a mounting section 60 wherein the cover section can be removably coupled to the top section which can be coupled to the mounting section 60. The cover section 12 can comprise a light emitting diode (“LED”) cover housing 14 that can be coupled to a back cover housing 18 wherein at least one LED ring 16 can be coupled between the LED cover housing and the back cover housing.

The LED cover housing 14 can be partially or fully transparent to allow the light to shine from the LEDs to shine through. The LED cover housing 14 can have a cover housing top 15 and a cover housing bottom 21 forming a LED housing interior 23. The LED cover housing 14 can be any suitable shape but in the preferred embodiment the LED housing is circular and in other embodiments the LED housing can be such as, for example, square, rectangular, oval, or the like. The LED cover housing 14 can have at least one cover protrusion 26 for the at least one LED ring 16 to be nested in. The LED cover housing 14 can be angled, with the circumference of the cover protrusions 26 gradually tapering as it extends away from the cover housing top 15. The cover protrusions 26 can be such as, for example, radiused, chamfered, angled, or the like. The LED housing interior 23 can have one or more attachment points 19 wherein a housing fastener can be coupled to the attachment points. The LED cover housing 14 can have a camera housing hole 24 axially centered on the LED cover housing. In certain embodiments, the camera housing hole can be omitted. The LED cover housing 14 can be made from such as, for example, plastic, metal, composite, ceramics or the like and can be clear to allow light to shine through from a plurality of LEDs 17.

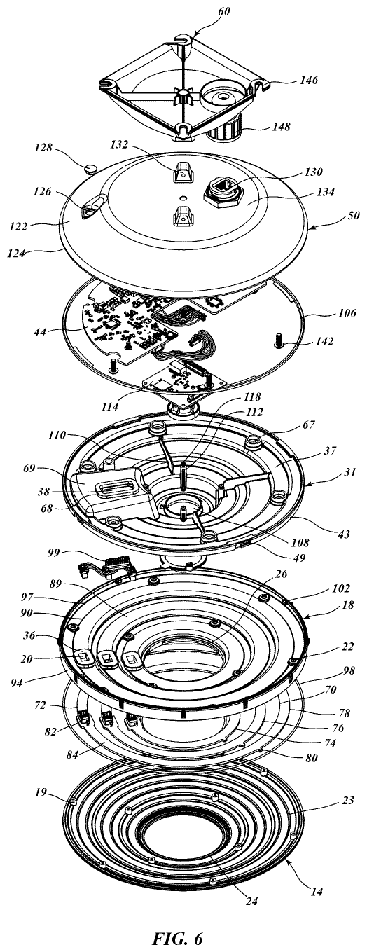

In embodiments, the LED cover housing 14 can coupled to the back cover housing 18 wherein the at least one LED ring 16 can be sandwiched between the LED housing and the back cover housing. The at least one LED ring 16 can have an inner ring circumference 70 and an outer ring circumference 72 and a LED top surface 84 and a LED bottom surface 86. In the preferred embodiment the at least one LED ring 16 is a first LED ring 74, a second LED ring 76, and a third LED ring 78 wherein the rings can increase in size from the first led ring 74 to the second LED ring 76 to the third LED ring 78 as shown in FIG. 6. In other embodiments, the at least one LED ring 16 can be any suitable shape and size such as, for example, circular, triangular, rectangular, square, polygonal, or the like.

In embodiments, the at least one LED ring 16 each ring's outer ring circumference can have an alignment tab which can correspond with an alignment recess 28 on the back cover housing 18. The at least one LED ring 16 can further comprise a LED electrical connection 82 coupled to the LED top surface 84 wherein the LED electrical connection can be such as, for example, a 4-pin connector, a 2-pin connector, DC barrel jack, socket plug, JST connector, Molex connector or the like. The plurality of LEDs 17 can be coupled to the LED bottom surface 86 and can be evenly or unevenly spaced axially around the LED bottom surface. The LEDs can be coupled together and can be coupled to the LED electrical connection 82 on each LED ring such as, the first LED ring 74, the second LED ring 76, and the third LED ring 78. The LEDs can emit at least one of such as, for example, red light, green light, blue light, yellow light, white light, or any combination thereof. The LEDs 16 can have a wavelength between 450 nm to 600 nm and more specifically a wavelength between 480 nm to 580 and even more specifically wavelengths between 510 nm to 532 nm.

The cover section 12 can be removably coupled to the top section 30 by at least one cover housing fastener 35 making it easy for the user to switch out the at least one LED ring 16 for a different LED ring that has at least one of a different color, wavelength or intensity allowing the user to customize the light emitting device 10 for particular grows such as, for example, mushrooms require blue light to have an optimal growth rate while other plants may require blue or red. In certain embodiments, the LED rings 16 can emit multiple colors allowing the user to choose which color to emit during different times of the day or for different plants within a grow wherein the user can set the light to change at a specified time and day to match optimal grow conditions for the plant.

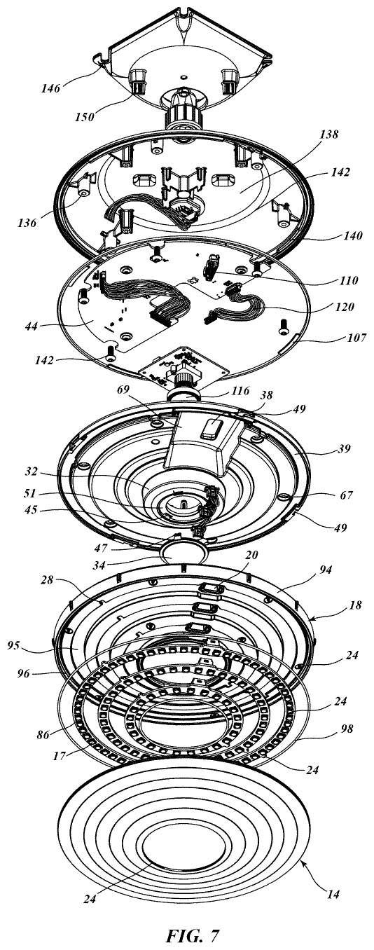

In embodiments, the back cover housing 18 can have back cover outer surface 94 and back cover inner surface 97 having thickness form a perimeter for the back cover housing and a back cover top 90 and a back cover bottom 92 forming a back cover inner compartment 89. The back cover bottom 92 can have at least one LED recess 95 wherein the at least one LED ring 16 can be removably or permanently coupled to the LED recess. The back cover outer surface 94 can extend vertically both up and down wherein the back cover outer surface can allow for the LED cover housing 14 to sit within the back cover outer surface as shown in FIG. 7. The back cover bottom can have a bottom seal recess 96 which can allow for a first seal 98 to be recessed within the back cover housing allowing the LED cover housing 14 to push up against the seal, sealing the two mating surfaces creating a waterproof housing for the LED rings 16 and its associated electrical components. The first seal 98 can be such as, for example, O-ring, gasket, lip seal, bonded seal, face seal, or the like. The back cover housing 18 can be stepped for each LED recess 95 wherein as the LED recess gets closer to the back cover hole 26 the steps get smaller in diameter wherein the steps can extend matching the angled LED cover housing 14 distance. In other embodiments, the back cover housing 18 can be such as, for example, flat, stepped, angled, parabolic, or the like in shape. The back cover housing 18 can be any suitable shape or size but in the preferred embodiment the back cover housing is circular in shape and can have three steps at varying diameters as shown in FIG. 7.

In embodiments, the back cover housing 18 can further comprise at least one electrical connection hole 20 wherein a grommet 33 can be coupled to the electrical connection. The LED ring electrical connection 82 can be placed into the grommet 33 through the electrical connection hole 20 wherein the fit between the LED ring electrical connection and the grommet can create a seal between the two. The grommet 33 can be such as, for example, rubber grommet, silicone grommet, neoprene grommet, nitrile grommet, thermoplastic grommet, or the like. Each LED ring electrical connection 82 can be placed within the grommet creating a watertight seal between the LED ring electrical connection and grommet. The LED ring electrical connection 82 can be coupled electrically by a female connector 99 which can have at least one male LED connection which can be coupled to the LED ring electrical connection 82 wherein the connection coupling can couple all the LED ring electrical connections together into one connection.

The back cover housing 18 can have a back cover hole 26 centered on the LED housing hole 24 and substantially the same size as the LED housing hole. The LED housing 14, LED 16 and the back cover housing 18 can be coupled together and can be removably connected to the top section 30. The back cover housing 18 can be made from such as, for example, plastic, metal, composite, ceramics or the like. In certain embodiments the back cover housing 18 can be such as, for example, oval, rectangular, square, hexagonal or the like and can be manufactured by such as, for example, molding, forming, casting, machining or the like. The back cover housing 18 can further comprise at least one locking tab 102 wherein the locking tab can be coupled to or integral to the back cover inner surface 97. In the preferred embodiment the at least one locking tab 102 can be spaced ninety degrees apart from each other.

In embodiments, the top section 30 can comprise a base top housing 31 that can be coupled to a base bottom housing 50 wherein a second seal 106 can be compressed between the base top housing and the base bottom housing. The base top housing 31 can be substantially the same shape as the back cover housing 18 wherein the top housing can comprise a top housing top surface 37, a top housing bottom surface 39 and a top housing outer surface 43. The top housing outer surface 43 can have one or more locking slots 49 coupled to or integral to the top housing outer surface wherein the locking tab 102 can be inserted into the locking slots and can removably couple the cover section 12 to the top section 30.

The top housing bottom surface 39 can have a camera housing protrusion 32 extending away from the top housing bottom surface forming a camera housing 108. The camera housing protrusion 32 can have one or more camera lens slots 45 and a camera lens recess 51 wherein a camera lens 34 can have one or more camera lens tabs 47 can be coupled to the camera housing protrusion by the camera lens slots and camera lens tabs. The camera lens 34 can partially sit within the camera lens recess 51. The camera lens 34 can be removable to fit the user's needs and the environment the light emitting device having a camera assembly 10 will be placed in. The camera lens 34 can be such as, for example, wide angle lens, macro lens, telephoto lens, fish-eye lens, bubble lens or the like and can be suitable to handle high humidity and fluctuating temperature environments. In certain embodiments, the camera lens 34 can be removably or permanently coupled to the camera protrusion by such as, for example, fasteners, tabs, clamp, adhesive, or the like and the camera lens 34 can be integrated within the camera and or image sensor 116.

In embodiments, the base top housing 31 can further comprise a top housing recess 69 wherein the top housing recess can have a second connection hole 38 with a second grommet 68 attached to it. The top housing recess 69 can be sized to allow for female connector 99, LED ring electrical connection 82, and male LED connection 100 to rest in wherein a main printed circuit board (“PCB”) 44 can have a male connector 110 can be coupled to the top section 30. The male connector 110 can be mated to and/or inserted within the second connection hole 38 wherein the male connector 110 can be coupled to the female connector 99. In certain embodiments the second grommet can be omitted, and the male connector can be sealed against the top housing recess.

In embodiments, the base top housing 31 can have at least one fastener support 67 spaced evenly or unevenly axially on the top housing surface 37. The top housing surface 37 can have at least one base top support 110 protruding axially spaced from the top housing surface 37. The base top housing 31 can have one or more camera PCB mounts 112 axially spaced around the upper portion of the camera housing 108 wherein a camera PCB 114 can be coupled to the PCB mounts by a camera PCB fastener 118. The camera PCB 114 can be coupled to an image sensor and/or camera 116 which can be housed in the camera housing 108. The image sensor and/or camera 116 can be coupled to a main PCB 44 by a ribbon connector 120. The main PCB 44, camera PCB 114 can have at least one controller and a wireless module wherein the controller can be such as, for example, a micro-controller, ESP32, System-on-Chip, PIC, programmable logic controller, digital signal processor, or the like and the wireless module can be such as, for example, Wi-Fi, Bluetooth, RFID, Cellular, or the like. The image sensor 40 can be such as, for example, charge-coupled device (“CCD”), complementary metal-oxide-semiconductor (“CMOS”) sensor, infrared (“IR”) sensor, thermal imaging sensor, back-illuminated sensor, or the like or if the image sensor 40 is a camera, the camera can use the light from the entire light spectrum. The camera PCB 114 can have a lens module coupled to it wherein the lens module can be such as, for example, fixed-focus lens module, auto-focus lens module, wide-angle lens module, macro lens module, panoramic lens module, infrared lens module, UV lens module or the like.

The user can control the LED 16 and image sensor 40 through a wireless connection connected to a portable computing device, smartphone, computer, or the like. The user can control and set remotely or through a wired connection through an attached Ethernet cable connection 130 such as, for example, duration of LED on/off, settings of image sensor and/or camera, LED color, image quality, exposure settings, metering mode, color profile, framing, focus settings, gain control, noise reduction, video encoding, time lapse, image stabilization, or the like.

In embodiments, a base bottom housing 50 can comprise a base bottom top 134 which can transition into a base bottom angled section 122 to a base bottom edge 124 and a base bottom surface 138 forming a base housing 142 which can cover the main PCB 44, camera PCB 114, and associated ribbon cables and connections. The bottom surface 138 can have at least one base fastener support 136 which can be aligned with and coupled to the top housing fastener hole 67 by at least one top section fastener 142 which can be such as, for example, bolts, screws, rivets, or the like. The base bottom edge 124 can have one or more second seal alignment guide 24 wherein the second seal can have an alignment guide 107 that can be aligned with the second seal alignment guide allowing the second seal 106 to be compressed between base bottom housing 50 and the top housing 31 creating a watertight seal. The second seal 106 can be such as, for example, O-ring, gasket, lip seal, bonded seal, face seal, or the like.

In embodiments, bottom base housing 50 can have a hole for an Ethernet cable connection 130 wherein the ethernet cable connection can be attached to the main PCB 44 by a ribbon cable and associated connections. The Ethernet cable connection 130 can be such as, for example, Ethernet connection, USB connection, USB-C connection, fiber optic connection, RJ11, Serial connection or the like. In certain embodiments the Ethernet cable connection 130 can be omitted and the main PCB can communicate wirelessly to a user. In embodiments the base bottom housing can have a light pipe hole 126 having a pipe hole cover 128 coupled to it. The light pipe hole 126 and light pipe cover 128 can channel or guide light from a light source or LED to a light sensor on the main PCB 44 allowing the board to automatically compensate for different light conditions within the greenhouse or other location. The light pipe cover 128 can be made from translucent material such as, for example, acrylic, polycarbonate or the like. The light sensor can detect the ambient conditions within the greenhouse. The light sensor 58 can be such as, for example, ALS light pipe, photonic sensor, infrared sensor, color sensor, ultraviolet sensor, or the like. The light sensor 58 can continuously check the presence of white light in the room to trigger the LED on and off, when necessary, for example during the daytime or day grow lights the LED may not be triggered and do not illuminate.

In embodiments, the base bottom housing 50 can be any suitable shape, but in the preferred embodiment it can be a circular shape or in other embodiments it can be such as, for example, square, rectangular, hexagonal, oval or the like. The base bottom housing 50 can be coupled to a mounting plate 60 by at least one male mount attachment 132. The mounting plate 60 can be removably coupled to the base bottom housing 50 by such as, for example, tabs, fasteners, snaps, clips and clamps, push pins, or the like. The mounting plate 60 can have at least one mounting hole 146 which can be attached to a wall or a ceiling of the grow facility or room. The mounting plate 60 can have an ethernet plug 148 coupled to the ethernet cable connection allowing for the ethernet cable to be routed out of the light emitting device 10. The mounting plate 60 can have at least one female mount attachment 150 which can be coupled to the at least one male mount attachment 132 by a mount fastener.

In embodiments, the light emitting device 10 can be used to provide camera security of indoor growing facilities. The plurality of LEDs 17 can be configured to mimic a natural light condition to at least one plant species. The plurality of LEDs 17 can mimic nighttime lighting, emit green light, or mimic moonlight. The plurality of LEDs 17 and the timing of the lighting can be controlled to affect a growth stage with different light color mimicking moonlight, sunlight, different light waves, ultraviolet light waves, infrared light waves, timing or the like with the different stages of growth, such as germination, seedling, vegetative, pre-flowering, and flowering.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only and is not intended to limit the scope of the present disclosure, which is defined solely by the claims. Accordingly, embodiments of the present disclosure are not limited to those precisely as shown and described.

Certain embodiments are described herein, including the best mode known to the inventors for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. Moreover, any combination of the above-described embodiments in all possible variations thereof is encompassed by the disclosure unless otherwise indicated herein or otherwise clearly contradicted by context.

We claim:

1. A light emitting device having a camera assembly comprising:
a cover section having a LED cover housing that is coupled to a back cover housing wherein at least one LED ring is coupled between the LED housing and the back cover housing;
a top section having a base top housing coupled to a base bottom housing wherein the base bottom housing has a camera protrusion wherein the base top housing and the base bottom housing encapsulates a main PCB, lens module and at least one controller wherein the cover section is removably attached to the top section encapsulating the at least one LED ring; and
a camera coupled to the camera protrusion and the at least one controller.

2. The light emitting device according to claim 1, wherein the cover section is partially or fully transparent.

3. The light emitting device according to claim 1, wherein the at least one LED is three rings increases in diameter size having at least one first electrical contact wherein the LED emits at least one of green, red, or yellow light.

4. The light emitting device according to claim 3, wherein the controller has at least on of a main printed circuit board (“PCB”) coupled to camera module having an image sensor and lens module.

5. The light emitting device according to claim 1, wherein the cover section has at least one hole for the camera protrusion to protrude through.

6. The light emitting device according to claim 5, wherein the first electrical contact is removably connectable with the second electrical contact completing the circuit between the main PCB and the three rings.

7. The light emitting device according to claim 1, wherein the camera protrusion has a lens removably coupled to it.

8. The light emitting device according to claim 7, wherein the lens is a bubble lens.

9. The light emitting device according to claim 1, wherein the base section is coupled to a mounting adapter plate.

10. The light emitting device according to claim 7, wherein the camera is able to use light from the entire spectrum.

11. A method of providing camera security of indoor growing facilities, the method comprising the acts of:
providing the light emitting device of claim 1 wherein the at least one LED is configured to mimic a natural light condition to at least one plant species.

12. The method of claim 11 wherein the LED mimics nighttime lighting.

13. The method of claim 11 wherein the LED emits green light.

14. The method of claim 11 wherein the LED mimic's moonlight.

15. The method of claim 11 further comprising swapping the LED and controlling the timing of the lighting to affect a growth stage.

16. The method of claim 15, wherein the growth stage is at least one of germination, seedling, vegetative, pre-flowering, and flowering.
